(19) United States
(12) Patent Application Publication
(10) Pub. No.: US 2009/0231868 A1
(43) Pub. Date: Sep. 17, 2009

(54) LED INDICATING ASSEMBLY FOR CAR OR MOTORCYCLE

(76) Inventor: A-Sheng YANG, Taipei Hsien (TW)

Correspondence Address: A-SHENG YANG, 235 Chung - Ho Box 8-24, Taipei, TW

(21) Appl. No.: 12/045,714

(22) Filed: Mar. 11, 2008

(51) Int. Cl. F21S 8/10; B62J 6/00

(52) U.S. Cl. 362/473

(57) ABSTRACT

An LED indicating assembly for a car or a motorcycle includes a circuit substrate arranged with a plurality of light emitting diodes and being extended with a power wire; a semi-transparent casing having a receiving space and a bottom plate; the receiving space being received with the circuit substrate; and the bottom plate serving to seal the circuit substrate in the semi-transparent casing; the semi-transparent casing having a shape of English characters, Chinese characters, or numbers. The light emitting diodes are surface mounted devices. The light emitting diodes are light sources of red light, orange light, yellow light, green light, and blue light so that the semi-transparent casing can emit red light, orange light, yellow light, green light, and blue light. Thus at night, the light emitting diodes will present the characters to present the nobility and fashion of the vehicles.

### FIELD OF THE INVENTION

The present invention relates to vehicle indicators, and particularly to an LED indicating assembly for a car or a motorcycle, wherein the LED indicating assembly has a semi-transparent casing and a circuit substrate with light emitting diodes therein. The semi-transparent casing may have shape of character or numbers. The characters and numbers are matched to brands, types, and indications of the car or motorcycle; and thus at night, the light emitting diodes will present the characters to present the nobility and fashion of the vehicles.

### BACKGROUND OF THE INVENTION

The brands, types, and numbers of a car or a motorcycle present the qualities of the vehicles. People understands the quality and price level of the vehicle from these information. Even from the same manufacturer, the qualities of the vehicles can be identified from the types and numbers.

Generally, the brands and types of the vehicles are presented by metal sheets with English characters thereon. In daytime, the brands, types, and numbers can be viewed by the illumination of sunlight, but at night, it is difficult to view these features.

Therefore, there is an eager demand for a novel design which provide LED indications or numbers so that even at night, by the emission of LED, the nobility and fashion of the vehicles can be presented.

### SUMMARY OF THE INVENTION

Accordingly, the object of the present invention is to provide an LED indicating assembly for a car or a motorcycle, wherein the LED indicating assembly has a semi-transparent casing and a circuit substrate with light emitting diodes therein. The semi-transparent casing may have shapes of character or numbers. The characters and numbers are matched to brands, types, and indications of the car or motorcycle; and thus at night, the light emitting diodes will present the characters to present the nobility and fashion of the vehicles.

To achieve above object, the present invention provides an LED indicating assembly for a car or a motorcycle, comprising; a circuit substrate arranged with a plurality of light emitting diodes and being extended with a power wire; a semi-transparent casing having a receiving space and a bottom plate; the receiving space being received with the circuit substrate; and the bottom plate serving to seal the circuit substrate in the semi-transparent casing; the semi-transparent casing having a shape of English characters, Chinese characters, or numbers.

The light emitting diodes are surface mounted devices.

The semi-transparent casing is electroplated with a layer of chromium which present the effect of semi-transparency. In daytime, the outer side of the semi-transparent casing is brighter than the interior thereof so that the semi-transparent casing presents the appearance of the chromium layer; the circuit substrate and the light emitting diodes therein can not be seen. At night, the circuit substrate will cause the light emitting diodes to light up, the interior of the semi-transparent casing is brighter than the outside so that the light from the light emitting diodes transmits out to the exterior of the semi-transparent casing.

The light emitting diodes are light sources of red light, orange light, yellow light, green light, and blue light so that after the semi-transparent casing can emit red light, orange light, yellow light, green light, and blue light.

Thus at night, the light emitting diodes will present the characters to present the nobility and fashion of the vehicles.

The various objects and advantages of the present invention will be more readily understood from the following detailed description when read in conjunction with the appended drawing.

### BRIEF DESCRIPTION OF THE DRAWINGS

FIG. 1 is an exploded perspective view of the present invention.

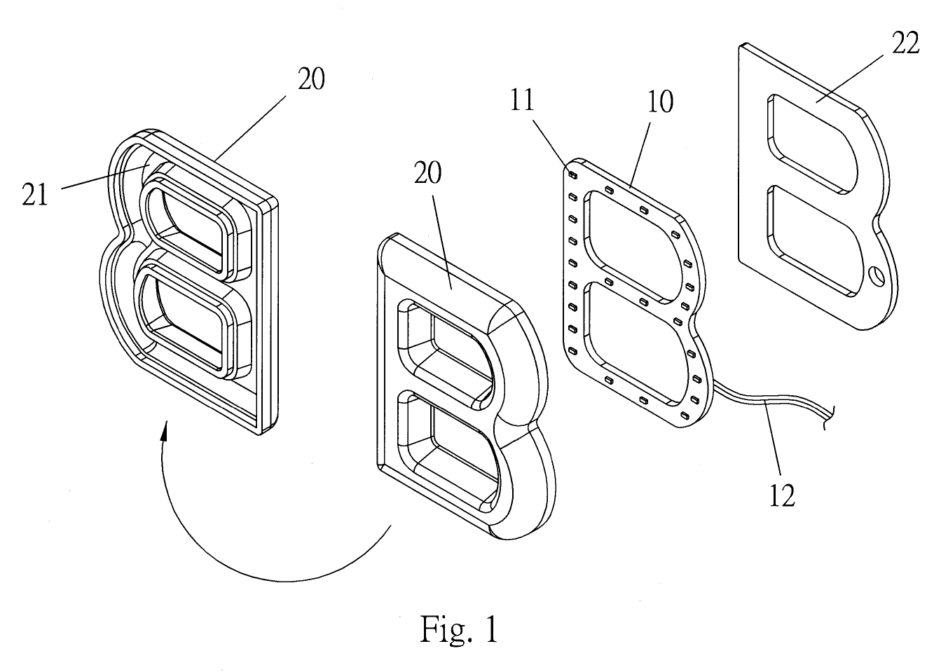

FIG. 2 is a schematic cross sectional view of the present invention.

FIG. 3 shows the first embodiment of the present invention.

FIG. 4 shows the second embodiment of the present invention.

### DETAILED DESCRIPTION OF THE INVENTION

In order that those skilled in the art can further understand the present invention, a description will be provided in the following in details.

However, these descriptions and the appended drawings are only used to cause those skilled in the art to understand the objects, features, and characteristics of the present invention, but not to be used to confine the scope and spirit of the present invention defined in the appended claims.

The present invention relates an LED indication for a car or a motorcycle as illustrated in the exploded perspective view of the present invention. The present invention has the following elements.

A circuit substrate 10 is arranged with a plurality of light emitting diodes 11. The circuit substrate 10 is extended with a power wire 12. The light emitting diodes 11 are surface mounted devices.

A semi-transparent casing 20 has a receiving space 21 and a bottom plate 22. The receiving space 21 serves for receiving the circuit substrate 10. The bottom plate 22 serves to seal the circuit substrate 10 in the semi-transparent casing 20. The semi-transparent casing 20 has a shape of alphas, words, texts, numbers, or others with a three dimensional shape.

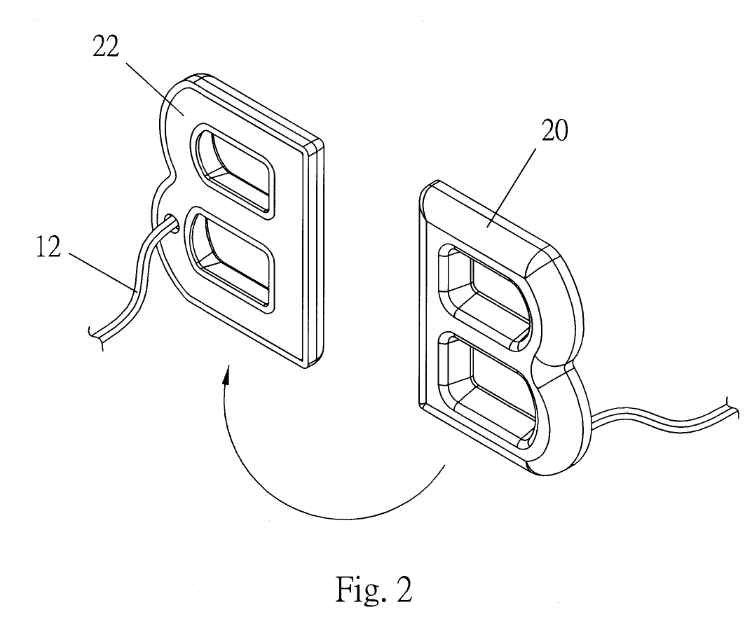

Referring to FIG. 2, the assembled schematic view of the present invention is illustrated. The semi-transparent casing 20 has a shape of English alpha of “B”. The power wire 12 of the circuit substrate 10 is connected to a battery of a car or a motorcycle. The battery serves to supply power to the light emitting diodes 11. The semi-transparent casing 20 is electroplated with a layer of chromium which present the effect of semi-transparency. In daytime, the outer side of the semi-transparent casing 20 is brighter than the interior thereof so that the semi-transparent casing 20 presents the appearance of the chromium layer. The circuit substrate 10 and the light emitting diodes 11 therein can not be seen. At night, the circuit substrate 10 will cause the light emitting diodes 11 to light up, the interior of the semi-transparent casing 20 is brighter than the outside so that the light from the light emitting diodes 11 transmits out to the exterior of the semi-transparent casing 20.

The light emitting diodes 11 may emit red light, orange light, yellow light, green light, blue light, etc. so that after the semi-transparent casing 20 is equipped with the light emitting diodes 11, it can present the red light, orange light, yellow light, green light, blue light, etc.

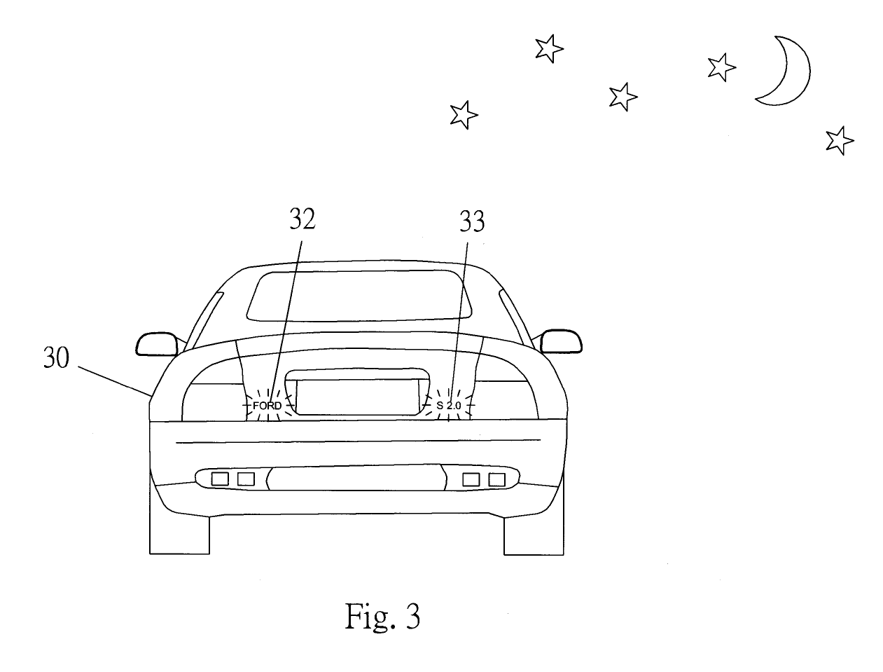

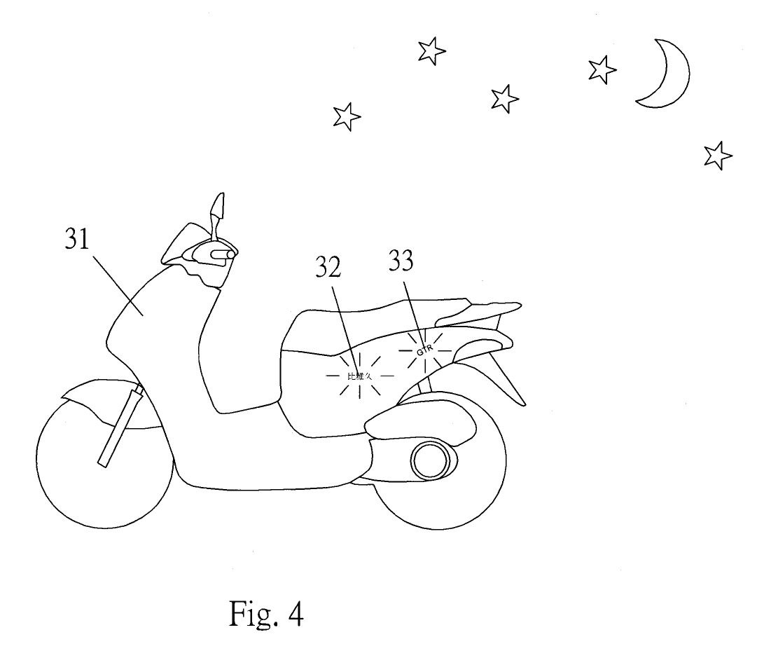

Referring to FIGS. 3 and 4, it illustrates that the present invention is embodied on a car 30 and a motorcycle 31. They can be indicated as the brands 32 or type numbers 33. In the present invention, it presents as indications or numbers of light emitting diodes of a car 30 or a motorcycle 31. The semi-transparent casing 20 may be brands 32 or type numbers 33, indications of the car 30 or motorcycle 31 to be attached. They are alphas of Chinese or English. At night, the light emitting diodes 11 emit light to present the nobility and fashion of the car 30 or motorcycle 31.

Advantages of the present invention will be described herein.

1. The present invention has a semi-transparent casing 20 which is fashionable and matched to the types, brands, type numbers, indications, etc. and can be presented as Chinese or English characters by using light emitting diodes to present light effect so as to present the fashion and nobility of the vehicles.

2. The light emitting diodes 11 may emit red light, orange light, yellow light, green light, blue light, etc. so that after the semi-transparent casing 20 is equipped with the light emitting diodes 11, it can present the ed light, orange light, yellow light, green light, blue light, etc.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An LED indicating assembly for a car or a motorcycle, comprising;
a circuit substrate arranged with a plurality of light emitting diodes and being extended with a power wire;
a semi-transparent casing having a receiving space and a bottom plate;
the receiving space being received with the circuit substrate; and the bottom plate serving to seal the circuit substrate in the semi-transparent casing; the semi-transparent casing having a shape of English characters, Chinese characters, or numbers.

2. The LED indicating assembly for a car or a motorcycle as claimed in claim 1, wherein the light emitting diodes are surface mounted devices.

3. The LED indicating assembly for a car or a motorcycle as claimed in claim 1, wherein the semi-transparent casing is electroplated with a layer of chromium which present the effect of semi-transparency; in daytime, the outer side of the semi-transparent casing is brighter than the interior thereof so that the semi-transparent casing presents the appearance of the chromium layer; the circuit substrate and the light emitting diodes therein can not be seen; at night, the circuit substrate will cause the light emitting diodes to light up, the interior of the semi-transparent casing is brighter than the outside so that the light from the light emitting diodes transmits out to the exterior of the semi-transparent casing.

4. The LED indicating assembly for a car or a motorcycle as claimed in claim 1, wherein the light emitting diodes are light sources of red light, orange light, yellow light, green light, and blue light so that the semi-transparent casing can emit red light, orange light, yellow light, green light, and blue light.

5. The LED indicating assembly for a car or a motorcycle as claimed in claim 1, wherein the characters and numbers are matched to brands, types, and indications of the car or motorcycle; and thus at night, the light emitting diodes will present the characters and numbers.

6. The LED indicating assembly for a car or a motorcycle as claimed in claim 1, wherein the power wire is connected to a battery of the car or motorcycle; and the battery serves to supply power to the light emitting diodes.
